(19) United States
(12) Patent Application Publication
(10) Pub. No.: US 2026/0048816 A1
(43) Pub. Date: Feb. 19, 2026

(54) DRIVE UNIT, VEHICLE DRIVABLE BY MUSCLE POWER, AND METHOD FOR ACTUATING A DRIVE UNIT

(71) Applicant: Pinion GmbH, Denkendorf (DE)

(72) Inventors: Michael Schmitz, Denkendorf (DE); Stefan Wolf, Denkendorf (DE)

(21) Appl. No.: 19/367,981

(22) Filed: Oct. 24, 2025

Related U.S. Application Data
(63) Continuation of application No. PCT/EP2024/060531, filed on Apr. 18, 2024.

(30) Foreign Application Priority Data
Apr. 25, 2023 (DE) 10 2023 110 561.2

(51) Int. Cl. B62M 25/08; B62M 6/45

(52) U.S. Cl. CPC B62M 25/08; B62M 6/45

(57) ABSTRACT

A drive unit for a vehicle, such as a bicycle driven by muscle power, having a transmission arrangement for setting up a plurality of gear stages, in which a form-fitting connection of two transmission elements is set up in each case. The transmission arrangement has an input shaft, which is connectable to drive cranks, and an output shaft, which can be coupled to an output, and having a control device for carrying out gear changes. The control device may be configured to carry out the following steps: receiving a gear-shifting request to a target gear stage, calculating an optimum starting condition of the shifting process, and starting the shifting process when the optimum starting condition is met, so that the form-fitting connection of the target gear stage is set up at an optimum time.

### CROSS-REFERENCE TO RELATED APPLICATIONS

This is a Continuation application of International patent application PCT/EP2024/060531, ﬁled April 18, 2024, which claims the priority of German patent application DE 102023 110 561.2 ﬁled April 25, 2023. Both application PCT/EP2024/060531 and DE 102023 110 561.2 are herewith incorporated by reference in their entireties.

### FIELD

The present invention generally relates to a drive unit for a vehicle and, in particular, for a vehicle drivable by muscle power, such as a bicycle, having a transmission arrangement for setting up a plurality of gear stages, in which a form-fitting connection of two transmission elements is set up in each case. The transmission arrangement may have an input shaft, which is connectable to drive cranks, and an output shaft, which can be coupled to an output, and it may have a control device for carrying out gear changes.

Furthermore, the present invention also generally relates to a vehicle that is drivable by muscle power and has such a drive unit, as well as to a method for actuating such a drive unit by means of the control device.

### BACKGROUND

Vehicles driven by muscle power, in particular bicycles driven by muscle power, often have gear shifts that define a plurality of gear stages. Traditionally, these are three-speed hubs, derailleur gears, but also transmission arrangements designed as intermediate transmissions, in which shiftable spur gear sets are assigned to the plurality of gear stages.

With this type of gear shifts, gear changes are generally carried out manually, for example using levers on a handlebar of the vehicle. However, it is also known to support such gear changes by a shift actuator system. In this case, gear-shifting requests are usually initiated by actuating electronic buttons or switches, which are connected to a control device. The control device is then usually used to actuate the shift actuator system, which often has a shifting motor.

In the field of vehicles driven by muscle power, it is also known to use a drive motor to support the torque applied by a driver of the vehicle. The drive motor is usually designed as an electric motor. Such bicycles are often also referred to as e-bikes or pedelecs. This type of vehicle also has a control device, which suitably adjusts a motor drive torque provided by the drive motor, which motor drive torque is usually provided in addition to a muscle-powered drive torque. As a rule, the adjustment is carried out in such a way that the motor drive torque provided by the electric motor is adjusted depending on a torque that is applied by muscle power. Vehicles equipped with such a drive motor also usually have a gear shift, even if fewer gear stages and/or a narrower spread of the available gear stages is often required. The gear shifts used for this purpose (usually derailleur gears or the spur gears mentioned above) are conventionally actuated by the actuation force of an operator.

DE 102012107939 B4 discloses a bicycle drive device which has a bicycle transmission designed as an internal transmission as well as an electric drive assist motor. A power control section controls a power of the drive assist motor. A feasibility determination section determines whether a gear-shifting process is feasible, by querying whether an output condition of a bicycle crankset meets a gear shift permissibility condition. Upon receiving a gear shift command, a gear shift control section instructs the power control section to stop or reduce the power of the electric drive assist motor when the speed of the vehicle is not zero. Furthermore, the gear shift control section instructs the transmission to carry out the gear-shifting process when the feasibility determination section has determined that the gear shift permissibility condition is met, namely, when the speed of the bicycle is zero. The transmission has a gear shift motor, which is actuated by the gear shift control section.

The output condition of the bicycle crankset that meets the gear shift permissibility condition may be a detected position of the bicycle crankset, may be a detected transmission torque of the transmission, or may be based on a detected rear wheel torque. Furthermore, the output condition may be based on a detected torque of a crank axle of the bicycle crankset. In general, the gear shift permissibility condition should be met if a crank arm is within a range of 20° from a top and/or a bottom dead center of the bicycle crankset.

WO 2020 / 221491 A1 discloses a transmission arrangement for a vehicle, in particular for a vehicle drivable by muscle power, which vehicle has an input shaft, an intermediate shaft, an output shaft, and a plurality of shiftable first gear sets. A machine gear is connected or connectable to one of the shafts. The drive torque of an electric machine can be introduced via the machine gear. The first gear sets connect the input shaft and the intermediate shaft and form a first partial transmission. At least a second shiftable gear set connects the intermediate shaft and the output shaft and forms a second partial transmission. The machine gear is arranged between the first partial transmission and the second partial transmission in the axial direction. A control device is used to actuate a shifting device for the gear sets and to actuate the electric machine. The control device is designed to carry out a shifting process of at least one of the gear sets by means of the shifting device during a time period within which a muscle power torque acting periodically on a drive shaft is minimal. The muscle power torque is usually minimal when the cranks are vertical (dead center position).

### SUMMARY

Against this background, it is an object of the present application to provide an improved drive unit for a vehicle, an improved vehicle drivable by muscle power, and an improved method for actuating a drive unit, wherein at least one gear change is improved, in particular with regard to comfort and/or loss of tractive force.

The above object may be achieved by: a drive unit for a vehicle, in particular for a vehicle drivable by muscle power, such as a bicycle, having a transmission arrangement for setting up a plurality of gear stages, in which a form-fitting connection of two transmission elements is set up in each case, wherein the transmission arrangement has an input shaft, which is connectable to drive cranks, and an output shaft, which can be coupled to an output, and having a control device for carrying out gear changes, wherein the control device is set up to carry out the following steps: receiving a gear-shifting request to a target gear stage, calculating an optimum starting condition of the shifting process, and starting the shifting process when the optimum starting condition is met, so that the form-fitting connection of the target gear stage is set up at an optimum time.

Furthermore, the above object may be achieved by a vehicle that is drivable by muscle power and has a drive unit according to the present application.

Finally, the above object may be achieved by a method for actuating a drive unit according to the present application by means of the control device, in particular with the aforementioned steps.

The drive unit according to the present application makes it possible, after receiving a gear-shifting request to a target gear stage (preferably from a source gear stage), to first calculate an optimum starting condition of the shifting process. When calculating the optimum starting condition, the following state variables of the drive unit or of the vehicle can in particular be taken into account: a current crank position, a current crank frequency (cadence), an intended speed of a shift actuator used to carry out the shifting process. Further state variables can be taken into account.

For example, the optimum starting condition can take into account the type of gear change, in particular whether it is a single gear change or a double or multiple gear change. A double gear change (also called double shift) is a gear change in which there is at least one further gear stage between a source gear stage and a desired target gear stage, i.e., for example, a gear change from gear stage 2 to gear stage 4. A single gear change is generally a gear change from a source gear stage to an adjacent target gear stage, i.e., for example, a gear change from gear stage 2 to gear stage 3.

Furthermore, when calculating the optimum starting condition, it is preferably taken into account whether it is an upshifting process (i.e., for example, from a low source gear stage to a higher target gear stage, e.g., from 2 to 3) or a downshifting process (e.g., from 3 to 2).

The establishment of the form-fitting connection of the target gear stage is usually accompanied by the release of the form-fitting connection of the source gear stage. When downshifting, the form-fitting connection of the source gear stage is typically released before the form-fitting connection of the target gear stage is established. When upshifting, the form-fitting connection of the source gear stage is usually released after the form-fitting connection of the target gear stage is established.

The optimum time is a time at which, for example, a crankset of the vehicle, via which muscle power is introduced for driving the vehicle, is in a certain position or in a certain range around such a position. For example, the optimum time is reached when the crankset is near a dead center position (where the cranks are aligned substantially vertically, regardless of which crankset pedal is at the top and which is at the bottom). The dead center position is the angle or angle range of the crankset at which the relatively lowest torque is introduced by muscle power. The highest muscle power torque is introduced when the crankset is aligned horizontally. By setting up the form-fitting connection of the target gear stage at the optimum time, the shifting process can be carried out at a relatively low load. This has a positive effect on shifting noise and consequently leads to less driver irritation. This improves the overall driving comfort. In addition, the shifting process can be carried out more reliably.

While the prior art teaches stopping or reducing the motor drive torque of the drive motor before a gear-shifting process is carried out (DE 102012107939 B4, see above), with the drive unit according to the present application, a shifting process can be carried out in most cases without reducing the motor drive torque of the drive motor. The optimum starting condition is calculated such that a shift time period required for the shifting process or an angle range of the crankset required for the shifting process is calculated. This calculation is preferably carried out depending on at least the current crankset position, the current crank frequency (cadence), and the actuator speed intended for the shifting process. Once this shift time period or shift angle has been calculated, the shifting process can be started when the expiration of the shift time period coincides with the optimum time, i.e., substantially when a dead center position of the crankset is reached. Herein, the shift time or shift time period is defined as a time period from the start of the shifting process until the form-fitting connection of the target gear stage is achieved or set up.

The start of the shifting process is preferably identical to the beginning of an actuation of a shift actuator. The shift actuator is preferably an electric shift actuator. The start of the shifting process therefore preferably coincides with the beginning of the energization of the shift actuator.

If reference is made herein to reaching the dead center position, it is understood that this can also mean an angle range around the dead center position, unless expressly defined otherwise.

The two transmission elements of the transmission arrangement, between which a form-fitting connection is created for setting up a gear stage, are preferably a shaft of the transmission arrangement (preferably an intermediate shaft) and an idler gear, mounted thereon, of a spur gear set that is assigned to a gear stage. An idler gear is generally a gear that is rotatably mounted on the shaft.

The form-fitting connection between these two transmission elements (shaft and idler gear) can be established in any way, e.g., by means of a dog clutch or a synchronized shift clutch (similar to manual transmissions in motor vehicles).

It is particularly preferred if the form-fitting connection between the two transmission elements (shaft and idler gear) is established by means of a shift pawl or a shift cam. Such a shift pawl is preferably mounted on one transmission element (shaft) so as to be pivotable substantially in the radial direction. Preferably, a camshaft is mounted so as to be rotatable radially in the interior of the shaft designed as a hollow shaft and is designed to move the shift pawl, depending on the relative rotational position between the camshaft and the shaft, either to a position in which no form-fitting connection is set up between the two transmission elements or to a position in which the form-fitting connection is set up between the two transmission elements.

With regard to the transmission arrangement, its shafts and the shifting arrangement for shifting gear stages of the transmission arrangement, reference is made to WO 2020/221491, the disclosure content of which is to be incorporated in full herein.

The object is thus fully achieved.

Overall, it is advantageous if the calculation of the optimum starting condition is carried out at least on the basis of (i) the current position of a crankset, (ii) the current rotational frequency (cadence) of the crankset, (iii) an intended (set) speed of a shift actuator used to set up the form-fitting connection of the target gear stage, and (iv) an actuator travel until the form-fitting connection of the target gear stage is set up.

With these four parameters, to which others may be added as described above and below, it is possible to calculate when it is optimal to initiate the shifting process, i.e., to actuate (in particular, to energize) the shift actuator, i.e., to start the shifting process when the optimum starting condition is met.

This makes it possible to ensure that the form-fitting connection of the target gear stage can be set up at an optimum time, in particular at a dead center position, i.e., when a relatively low torque is applied to the crankset.

As mentioned above, with the drive unit according to the present application, it is generally not necessary to reduce a motor drive torque of a drive motor for or during a gear change. This applies in particular to so-called single gear changes.

In a preferred embodiment, which is in particular applicable to double or multiple gear changes, which require more time than a single gear change, a drive motor of the drive unit is set up to feed a motor drive torque for driving the vehicle into the transmission arrangement, wherein the control device is set up to reduce the motor drive torque of the drive motor after the shifting process has started.

This allows the time for which the motor drive torque is reduced to be reduced compared to the prior art (where the motor drive torque is reduced before the gear change is initiated), so that the gear changes can be designed to be more comfortable.

According to a further preferred embodiment, the control device is set up to reduce the motor drive torque of the drive motor before the form-fitting connection of the target gear stage is set up.

This variant also preferably applies only to double or multiple gear changes, but preferably not to single gear changes.

It is understood that the motor drive torque is preferably increased again, in particular in a gear-dependent manner, after the form-fitting position is reached. The motor drive torque is preferably increased again as quickly as possible and, in some cases, can be increased again before the form-fitting position is reached.

According to a further preferred embodiment, the control device is set up to adapt a motor speed of a drive motor to a gear ratio of the target gear stage when the form-fitting position of the target gear stage is reached.

This type of adaptation is carried out in particular in the case of single shifts.

Alternatively, the control device is set up to adapt a motor speed and/or a motor drive torque of a drive motor to a gear ratio of the target gear stage a time period before a form-fitting position of the target gear stage is reached.

This alternative is used in particular for double upshifts. Herein, the term “double shift” is to include, on the one hand, shifting processes that are to be carried out via an intermediate gear stage, i.e., for example, from gear stage 2 to gear stage 4. However, the term “double shift” can also include shifting processes in which a gear stage change (whether direct or via an intermediate gear stage) involves one shift each in two partial transmissions. The latter applies in particular to transmission arrangements that include two partial transmissions in the manner of a group transmission, as disclosed in the aforementioned document WO 2020/221491.

In general, it is preferred to change the motor drive torque and the motor speed in a coordinated manner when the form-fitting position of the target gear stage is reached. This can prevent gear changes from being perceived as “inharmonious.”

Overall, as already described above, it is advantageous if the control device is connected to a shift actuator system that has a shifting motor, preferably an electric shifting motor.

The shift actuator system may include conventional dog clutches or means for axially displacing gears or synchronized shift clutches, similar to manual transmissions in motor vehicles.

However, it is particularly preferred if the shift actuator system has a camshaft, which is preferably arranged coaxially with an intermediate shaft, in particular in the interior of an intermediate shaft.

In this case, it is further preferred if shift pawls or shift cams are mounted on the intermediate shaft and, by means of a relative rotation of the camshaft with respect to the intermediate shaft, either engage with idler gears rotatably mounted on the intermediate shaft (in order to establish the form-fitting connection for the assigned gear stages) or disengage therefrom in order to release a form-fitting connection.

For details of such a shift actuator system, reference is made to WO 2020/221491, the disclosure of which is incorporated herein by reference.

It is further preferred if the control device is set up to actuate the shift actuator system in the direction of a form-fitting position of the target gear stage when a shifting request is received and to terminate the actuation after the form-fitting position is reached and/or before a target position is reached, so that the target position can be reached due to mass inertia.

In general, it is also conceivable to terminate the actuation beforehand, i.e., for example, to no longer energize an electric shifting motor before the form-fitting position is reached. As a rule, however, the actuation of the shift actuator system is not yet terminated when the form-fitting position is reached, since a source gear stage must preferably be disengaged afterwards and a certain shift actuator force (or shift actuator torque) is also required for this purpose.

A target position is therefore a position at which the gear change is completed, i.e., a target gear stage is engaged and, if applicable, a source gear stage is disengaged.

According to a further preferred embodiment, the calculation of the optimum starting condition of the shifting process includes calculating whether a form-fitting position of the target gear stage can be reached when the next dead center position of the input shaft is reached or whether the form-fitting position of the target gear stage can only be reached when the second subsequent dead center position of the input shaft is reached.

In this case, the input shaft is generally connected to a crankset. Starting from the current crankset position, the next dead center position is the position of the crankset at which the cranks of the crankset are next aligned vertically.

When calculating the optimum starting condition, there is usually a certain time required from the current state until the form-fitting connection of the target gear stage is reached, in particular a certain time period (shift time) or a certain shift angle range (which is proportional to the shift time if the rotational speed of the crankset is constant).

If, for example, the crankset is relatively close to a dead center position, there may not be enough time to set up the form-fitting connection until this (i.e., the next) dead center position. In this case, the control device detects that the shifting process is only started when the next dead center position has been passed through, namely, optimally before the second subsequent dead center position is reached, or, if, for example, the cadence is very high and the shift time is very long, optimally before the third subsequent dead center position is reached.

This ensures that the shifting process can always be started optimally depending on the current crankset position.

According to a further preferred embodiment, the control device is set up to adjust an actuator speed of a shift actuator system depending on the type of shifting process.

The actuator speed is usually adjusted by the variable of a current (actuator variable) of an electric shift actuator, in particular of an electric shifting motor, namely, via a suitable pulse width modulation setting (PWM variable) or, in the case of a BLDC motor, by a corresponding actuation thereof.

If the shifting process is to be as fast as possible, a higher actuator speed is selected. This is in particular the case with double or multiple shifts. For single shifts, on the other hand, it is usually sufficient to select a lower actuator speed. This can reduce the wear and tear and also the energy consumption for carrying out the shifting process. Furthermore, the driver’s perceived shift duration can be harmonized.

It is therefore particularly preferred if the control device is set up to set the actuator speed of the shift actuator system to be higher for a two-fold or double gear change than for a single gear change.

According to a further preferred embodiment, the control device is set up to detect an actuator position of a shift actuator system for carrying out gear changes and, in the event that the shift actuator system has exceeded an actuator position corresponding to the target position of the target gear stage, during a shifting process to a target gear stage, to actuate the shift actuator system in an opposite direction.

This embodiment relates to a case in which, for example, due to an excessively high actuator speed, the shift actuator system has moved past the target position. In this case, the shift actuator system is moved back in order to then, subsequently, actuate the shift actuator system again in the direction of the target position in order to make a second attempt to complete the gear change.

It is preferred in this case if the control device is set up to reduce an actuator speed of the shift actuator system in the direction of the target position during such a subsequent actuation.

This can ensure that the probability of another “overshoot” is reduced. Otherwise, a constant “ping-pong effect” could occur between overshooting the target position, moving back, and overshooting the target position again.

According to a further preferred embodiment, the control device is set up to detect an actuator position of a shift actuator system for carrying out gear changes and, in the event that the actuator position does not change for a specific blocking period during a shifting process to a target gear stage before a form-fitting position of the target gear stage is reached, to actuate the shift actuator system in a pulsating manner with regard to a control variable and/or to actuate the shift actuator system back and forth in a pulsating manner with regard to a shift travel.

This embodiment is based on a case in which, for whatever reason, a certain blockage of the shift actuator system occurs before the form-fitting position is reached. In order to resolve this blockage, the shift actuator system is preferably switched on and off quickly in order to “shake off” the blockage due to this pulsating actuation. Alternatively or additionally, the shift actuator system can be actuated back and forth in a pulsating manner with regard to the shift travel, so that a kind of hammer movement takes place against the blocking position in order to release this blockage.

It is particularly preferred if the control device is set up to abort the shifting process if, despite the pulsating actuation of the shift actuator system for a pulsation period or for a predetermined (maximum) number of pulses, the form-fitting position of the target gear stage is not reached.

In other words, if it is not possible to release the blockage even by pulsating actuation of the shift actuator system (either with regard to the control variable or with regard to the shift travel), the shifting process is aborted and the source gear stage remains engaged. Preferably, the shift actuator system is in this case moved back to the actuator position of the source gear stage. If necessary, an error message is output.

According to a further preferred embodiment, the control device is set up to detect a multiple shifting request (e.g., a request for a double gear change or a multiple gear change) and, in this case, to set the actuator speed of a shift actuator system to be higher than for a single gear change. This was already discussed above and relates not only to double gear changes but also to multiple gear changes. A multiple gear change is understood as shifting by more than one gear stage within a short time.

In general, it is assumed that in the case of a shift actuator system that uses a camshaft, as discussed above, a camshaft adjustment angle for carrying out a double shifting process is >150°, in particular >170°. As a result, the shifting process must be started significantly earlier in a double shifting process than in a single shifting process, in which an adjustment angle for carrying out the entire gear change is usually less than 90°, in particular less than 70°.

In order to avoid making the shift times too different, the actuator speed is increased for a double shifting process or multiple shifting process.

According to a further preferred embodiment, the control device is set up to check, after the form-fitting connection of the target gear stage has been established, whether the form-fitting connection has been set up at the optimum time and, if not, to include the deviation in the future calculation of the optimum starting condition.

This allows the algorithm for calculating the optimum starting condition to be executed in a self-learning manner.

In order to detect when or at which crank angle position the form-fitting connection was achieved, a change in the input or output speed, a change in the course of the (driver) input torque, an observation of the power requirement of the shift actuator motor, or a change in the shift actuator motor speed can be used, for example. Typically, for example, the speed of the shift actuator increases significantly when the blockage is overcome or when the form-fitting connection “engages.”

According to a further preferred embodiment, the control device is set up to learn a dead center position and preferably to include it in the future calculation of the optimum starting condition.

Preferably, the learning of the dead center position can be carried out by the setter/driver on the basis of a manual calibration (preferably initially during commissioning). For this purpose, the control device can be set up to prompt a setter/driver via a selectable menu item to manually set up and confirm a dead center position and to save the result.

Alternatively or additionally, the learning may include updating the dead center position during operation, preferably a permanent update. The update can, for example, be initiated by the control device, preferably autonomously, when a significant deviation of currently detected dead center positions compared to a stored dead center position occurs and is detected.

For example, a current value of the dead center position can be stored in the control device. Furthermore, a detection algorithm for the dead center position can be stored in the control device.

The detection algorithm preferably detects the current dead center position depending on the torque that a driver feeds into the transmission arrangement (driver torque). For this purpose, a torque detection device can, for example, be provided, as described in the aforementioned document WO 2020/221491 under reference sign 48.

In this case, the control device is preferably set up to monitor the driver torque over a certain angle of rotation (e.g., approximately 1 revolution or a number n of crank position measurement values). Here, it is preferably provided to interpret the minimum of the driver torque and the corresponding crank position within this measurement series as the dead center position.

In general, a single detection of the dead center position is sufficient. Preferably, however, this detection is carried out regularly, particularly preferably permanently, i.e., continuously, in particular when a significant deviation is detected (see above).

The dead center positions ascertained due to the regular detection can preferably be averaged. Particularly preferred is the formation of a moving average, in particular on the basis of a FIFO buffer memory which stores the n last detected dead center positions. The value of n may, for example, be in the range of 10 to 1000, preferably in the range of 50 to 200.

With these ascertained dead center positions, a permanent average can be updated, for example. The stored dead center position thus becomes more and more accurate.

If the dead center position suddenly deviates significantly (for example because the cranks have been mounted offset in the meantime), the learned average of the dead center position is preferably reset and the learning process starts again.

When ascertaining the dead center position, not only the driver torque curve but also other variables, such as the cadence curve, can be used, for example.

It is understood that the features mentioned above and those to be explained below can be used not only in the combination specified in each case but also in other combinations or on their own without departing from the scope of the present invention.

### DRAWINGS

Exemplary embodiments are shown in the drawings and are explained in more detail in the following description. In the drawings:

FIG. 1A is a schematic representation of a vehicle driven by muscle power having a drive unit according to an embodiment;

FIG. 1B is a schematic representation of different angular positions of a crankset of the drive unit of FIG. 1A;

FIG. 2 shows time sequence diagrams of a cadence, a crank position, a motor drive torque of a drive motor, a shifting request and a shift motor actuation during a shifting process;

FIG. 3 is a diagram of a control variable of a shift actuator over a shift travel position;

FIG. 4 is a time sequence diagram of an actuator control variable over time in a pulsating actuation; and

FIG. 5 is a representation of an actuator position over time in a pulsating actuation with forward and backward movement.

### DETAILED DESCRIPTION

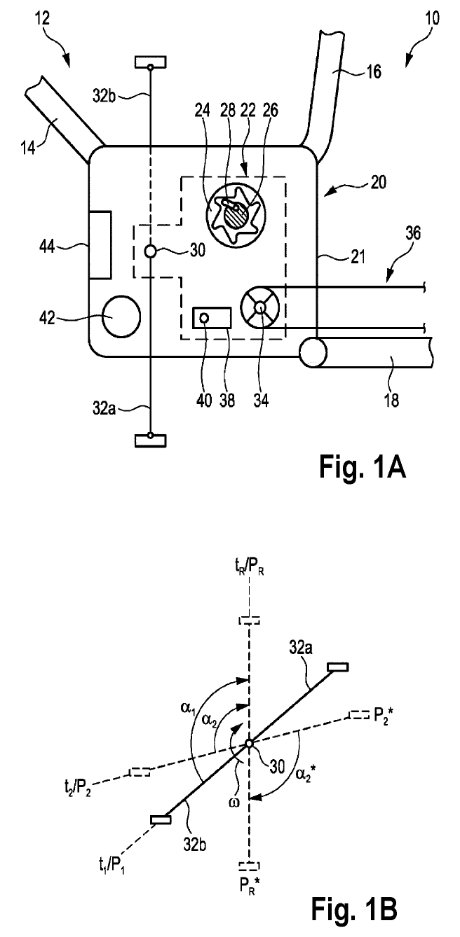

In FIG. 1A, a bicycle 10 with a frame 12 is shown in schematic form. The frame 12 includes a down tube 14, a seat tube 16, and a rear triangle 18 (swingarm). The bicycle 10 further includes a drive unit 20.

The drive unit 20 has a housing 21, which is fixed to the frame 12. The drive unit 20 includes a transmission arrangement 22, schematically indicated in FIG. 1A, for setting up a plurality of gear stages, in which a form-fitting connection of two transmission elements is set up in each case. FIG. 1A schematically shows a first transmission element 24, for example in the form of an idler gear, which is rotatably mounted on an intermediate shaft 26. An intermediate shaft 26 can form a second transmission element.

By setting up a form-fitting connection between the first and the second transmission element 24, 26, the first transmission element 24 is connected for conjoint rotation to the second transmission element 26 in the circumferential direction in order to engage a gear stage assigned to the first transmission element 24. In order to set up the form-fitting connection, a form-fitting element can be used, such as a shift pawl (or a shift cam), which can be actuated by means of a camshaft not shown in FIG. 1A.

The transmission arrangement 22 includes an input shaft 30, which is connected for conjoint rotation to a crankset, which includes drive cranks 32a, 32b in a manner known per se. FIG. 1A shows the crankset in a dead center position, i.e., a vertical position.

The transmission assembly 22 further includes an output shaft 34, which is connected to an output 36, i.e., for example, to a chain drive to a rear wheel (not shown) of the bicycle 10. Preferably, the output shaft 34 is therefore connected for conjoint rotation to a sprocket or to a toothed belt pulley or the like.

The transmission arrangement 22 further includes a shift actuator system 38, which is shown schematically in FIG. 1A. The shift actuator system 38 can include the aforementioned camshaft, by means of which the form-fitting elements 28 can be actuated for engaging and disengaging gear stages. The shift actuator system preferably includes a shift actuator, in particular in the form of an electric shifting motor 40, which is designed to rotate the camshaft, in particular relative to the intermediate shaft 26. In a special design, the shift actuator system and/or an electric shifting motor can also be placed within the intermediate shaft or another shaft.

The drive unit 20 further includes a drive motor 42, which is designed to feed a motor drive torque for driving the vehicle into the transmission arrangement 22. The drive motor 42 is preferably an electric motor, which preferably feeds additional drive power into the transmission arrangement, i.e., in addition to a muscle power torque fed via the crankset.

The drive motor 42 is actuated by means of a control device 44. Preferably, the drive motor 42 is actuated depending on the variable of a muscle power torque that is fed in via the crankset.

The drive unit 20 may substantially correspond to a drive unit as disclosed in WO 2020/221491, the disclosure of which is incorporated herein by reference. The transmission arrangement 22 here corresponds to a transmission arrangement 16 there. The cranks 32a, 32b here correspond to cranks 18, 18' there. The first transmission element 24 here in the form of an idler gear corresponds to an idler gear of a plurality of idler gears of shiftable gear sets R1 to R7 there. The second transmission element 26 here corresponds to an intermediate shaft there. The form-fitting element 28 here corresponds to the shift pawls S1 to S7 there, which are shifted by means of the corresponding shift cams N1 to N7 of a camshaft 44. The input shaft 30 here corresponds to a drive shaft 26 there. The output shaft 34 here corresponds to an output shaft 36 there. The output 36 here corresponds to a chainring 20 there. The electric shifting motor 40 here corresponds to a shifting motor 68 there. The drive motor 42 here corresponds to an electric machine 22 there. The control device 44 here corresponds to a control device 88 there. As described in WO 2020/221491, the drive unit 20 here (drive unit 10 there) can comprise a plurality of sensors, for example an adjustment angle sensor 54 for detecting a position of the crankset and preferably for simultaneously detecting a rotational frequency of the crankset. Furthermore, the drive unit 20 here can include a shift position sensor 72, by means of which an actuator position of a shift actuator can be detected and by means of which an actuator travel of the shift actuator can be detected. In addition, the drive unit here can include a rotor position sensor 76 for detecting a rotor position of the drive motor 42.

The control device 44 here is set up to receive a gear-shifting request to a target gear stage, to calculate an optimum starting condition of the shifting process required for this purpose, and to start the shifting process when the optimum starting condition is met, so that the form-fitting connection of the target gear stage is set up at an optimum time, in particular at the time of reaching a dead center position, as shown in FIG. 1A.

This is shown schematically in FIG. 1B. In solid lines, the crankset 32a, 32b is shown in a current position in which it is arranged a current crankset angle α₁ away from the next dead center position, assuming that the crankset rotates in a drive direction at an angular speed ω (corresponding to a cadence).

It is assumed that, in the current position shown, which is denoted by t₁, P₁ in FIG. 1B, a gear-shifting request to a target gear stage is received. An optimum starting condition of the shifting process is then calculated, namely on the basis of the current position α₁ of the crankset, the current rotational frequency (angular speed) of the crankset (corresponding to ω), a speed of a shift actuator 40 used to set up the form-fitting connection of the target gear stage, and an actuator travel until the form-fitting connection of the target gear stage is set up. This results in a specific shift time, which, at the assumed rotational frequency, corresponds to a crank travel or a crank angle range, which is indicated by α₂ in FIG. 1B. If the form-fitting connection of the target gear stage is to be established when the dead center position denoted in FIG. 1B by t_{R}, P_{R} is reached, the shifting process in the present embodiment is started or initiated (e.g., by energizing the electric shifting motor 40) at an optimum crankset position P₂ (corresponding to an optimum starting time for the start of the shifting process), so that, at an assumed constant angular speed ω of the crankset 32a, 32b, the form-fitting connection of the target gear stage is reached exactly at the form-fitting position P_{R}, i.e., at the next or following dead center position. It is understood that, instead of an optimum starting condition in the form of an optimum crankset position, the optimum starting time t₂ can also form an optimum starting condition, wherein the calculated time t_{R} of reaching the form-fitting position is then used as a basis.

If the current crankset position in the representation of FIG. 1B upon receipt of the gear-shifting request is such that the sequence or the end of the shift travel α₂ is behind the form-fitting position P_{R} in the direction of rotation, the optimum crankset position P₂* is assumed to be a position that is so far in front of the second subsequent dead center position that, with the calculated crank angle range α₂*, the form-fitting position P_{R}* is reached with the second subsequent dead center position, i.e., usually less than one full crankset rotation later.

Since the form-fitting connection of the target gear stage is set up at a dead center position, the target gear stage can be engaged particularly comfortably and quietly. Usually, the shifting process can be carried out without reducing a motor drive torque provided by the drive motor 42.

If the gear-shifting process includes a double shift, in which the required crank angle range α₂ is usually longer than shown in FIG. 1B, e.g., > 150°, it may however be advantageous to reduce the motor drive torque of the drive motor, but only after the shifting process has started and usually before the form-fitting connection of the target gear stage is set up.

In such a desired double shifting process, it is also preferred if an actuator speed of the shift actuator system 38 (angular speed of the electric shifting motor 40) is increased compared to an actuator speed that is set in a single shifting process.

In the case of double upshifts, it is also preferred if a motor speed of the drive motor is adapted to the new gear ratio of the target gear stage a time period before the form-fitting position of the target gear stage is reached.

As mentioned above, in single shifts, it is usually sufficient to adapt the motor speed and/or the motor drive torque of the drive motor to the gear ratio of the target gear stage when the form-fitting position is reached.

In general, in gear changes in which a form-fitting connection change is to be carried out between transmission elements (such as double shifts in two partial transmissions) that are subject to the motor drive torque, it is preferred to reduce the motor drive torque before the form-fitting connection change.

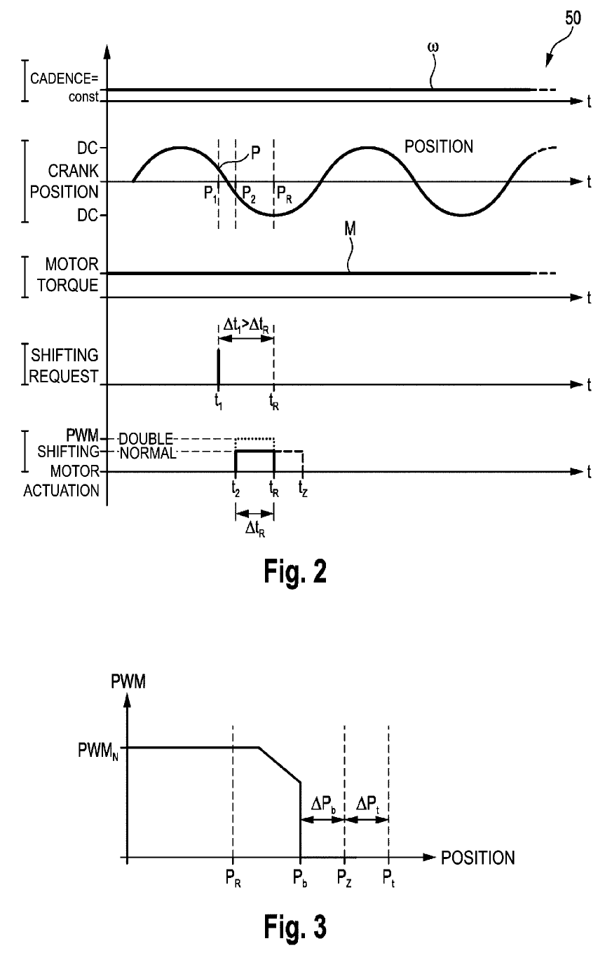

FIG. 2 schematically shows a time sequence of a shifting process. FIG. 2 shows various time sequence diagrams 50, including of a cadence or angular speed ω of the crankset over time, of a crank position P over time, of a motor torque M of the drive motor 42 over time, of a shifting request trigger over time, and of an actuator variable (PWM corresponding to a motor current) of the electric shifting motor 40.

FIG. 2 shows that ω is substantially constant. This results in an substantially harmonic sinusoidal oscillation of the crank position between two dead center positions DC, DC (shown is essentially the temporal progression of the position of one crank in order to show the shifting process in a simplified manner overall).

Furthermore, for the sake of simplicity, it is shown that the motor drive torque M can remain substantially constant, i.e., is not reduced during a shifting process. However, as mentioned above, it is preferred if the motor drive torque M follows the driver torque approximately sinusoidally, in particular is proportional to the driver torque (not shown). Even in this alternative, the motor drive torque M is preferably not reduced during a shifting process.

It is also shown that a shifting request is received at time t₁. The shifting request is received according to FIG. 2 at a crank position P₁ that is just before a middle position between two dead center positions, similar to the crank position P₁ in FIG. 1B. Upon receipt of the gear-shifting request, the control device calculates the optimum starting condition of the shifting process, namely, an optimum starting time t₂ (see FIG. 2) corresponding to an optimum crank position for the start of the shifting process (P₂). At this time t₂, energizing the electric shifting motor 40 is started (PWM = normal for a single shift or PWM = double for a double shift). The energization is carried out at least for a period Δt_{R} until the next dead center position DC (corresponding to P_{R} and t_{R} in FIG. 2) is reached.

By appropriately determining the beginning of the shifting process, it is possible to ensure that the form-fitting position of the shift actuator system is reached exactly at the time of reaching (t_{R}) the dead center position.

In general, it is conceivable to terminate the actuation of the electric shifting motor 40 when the form-fitting position is reached. However, FIG. 2 shows that the electric shifting motor 40 is still energized for a further time period after the form-fitting position t_{R} is reached, namely until a target position is reached at a time t_{Z}, at which it is achieved that not only the form-fitting connection of the target gear stage has been achieved, but the source gear stage has also been disengaged.

The shift pawls, as described, for example, in WO 2020/221491, are usually designed as freewheel pawls so that, in particular during upshifts, the source gear stage can remain engaged until a point in time after the form-fitting connection of the target gear stage has been established. When the target position is reached, the source gear stage is then disengaged, so that the associated shift pawl is no longer in the freewheel position but actually disengages from the associated transmission element.

FIG. 3 shows the energization of the electric shifting motor 40 over the position of the electric shifting motor 40 (corresponding to a camshaft position of a camshaft).

It can be seen that the motor is energized until after the form-fitting position P_{R} of the target gear stage has been reached. A target position P_{Z} lies behind the form-fitting position P_{R} in the actuator movement direction. In the target position P_{Z}, the source gear stage is disengaged.

In order to avoid that, for example, due to backlash in the shift actuator system 38 and/or due to mass inertia, the target position P_{Z} is accidentally “overrun,” the electric shifting motor 40 is preferably switched off even before the target position P_{Z} is reached, as shown at P_{b} (below the acceptance limit for the target position P_{Z}). FIG. 3 also shows a lower acceptance range ΔP_{B} and an upper acceptance range ΔPₜ for the target position. The electric shifting motor 40 should be switched off such that the time P_{b} is within the tolerance or acceptance range.

The lower acceptance range ΔP_{b} lies between the target position P_{Z} and the lower acceptance limit P_{B}. The upper acceptance range ΔP ₜ lies between the target position P_{Z} and the upper acceptance limit for the target position (Pₜ).

Alternatively, instead of prematurely switching off the electric shifting motor 40, it is also possible to provide a permanent control loop (e.g., PID controller), by means of which the target position is controlled (by comparing the target position as the desired position with the current actuator position).

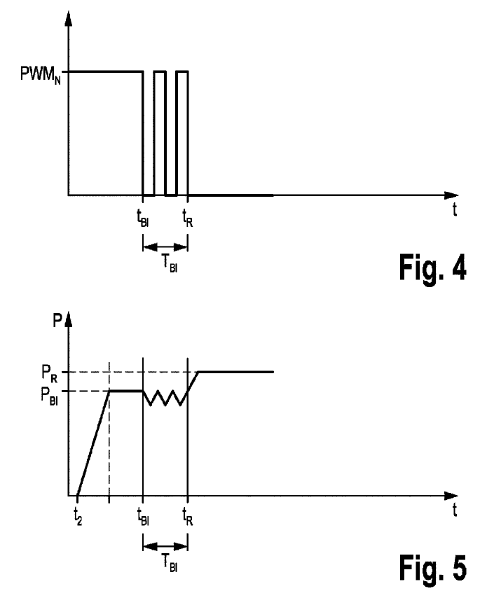

FIG. 4 schematically shows a time sequence when a blockage occurs (blockage time t_{Bl}) before the form-fitting position (corresponding to a time t_{R}) is reached. In this case, the actuation of the electric shifting motor 40 can be carried out in a pulsating manner such that the control variable (PWM) is switched on and off in a pulsating manner. FIG. 4 shows that the actuator variable is completely switched off. However, a reduction in the actuator variable with a pulse-like characteristic can also be provided. The pulsating actuation is carried out over a blocking period T_{BL}, within which the form-fitting position at t_{R} should be reached. Instead of a blocking period, a number of pulses can also be measured. The term “blocking period” can therefore also refer to a specific number of pulses.

If the form-fitting position is not reached within the blocking period T_{BL}, the shifting process is aborted and the shift actuator system returns to the position of the source gear stage.

FIG. 5 shows a further measure for releasing a blockage at a time t_{Bl}. FIG. 5 shows a shift travel position P_{Shift} plotted over time. A form-fitting position is shown at P_{R}.

When the electric shifting motor 40 is moved in the direction of the form-fitting position P_{R} after the beginning of the shifting process (t₂), a blockade may occur at a certain time t_{Bl}, as mentioned above. Instead of switching a current of the electric shifting motor 40 on and off, as shown in FIG. 4, the electric shifting motor 40 can also be moved back and forth once or several times, as shown during the blocking period T_{Bl} in FIG. 5, so that the shift actuator essentially “hammers” against the blocking position until finally, hopefully, the form-fitting position at t_{R} is reached. If the form-fitting position P_{R} is not reached, the shifting process is aborted, as in the example in FIG. 4.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance, “such as,” and “like,” and the verbs “comprising,” “having,” “including,” and their other verb forms, when used in conjunction with a listing of one or more components or other items, are each to be construed as open ended, meaning that the listing is not to be considered as excluding other, additional components or items. Other terms are to be construed using their broadest reasonable meaning unless they are used in a context that requires a different interpretation.

### List of reference signs:

10 Bicycle

12 Frame

14 Down tube

16 Seat tube

18 Rear triangle (swingarm)

20 Drive unit

21 Housing

22 Transmission arrangement

24 First transmission element (e.g., idler gear)

26 Second transmission element (e.g., intermediate shaft)

28 Form-fitting/positive-fitting element (e.g., shift pawl or shift cam)

30 Input shaft

32a/b Drive cranks

34 Output shaft

36 Output (e.g., chain drive to the rear wheel)

38 Shift actuator system

40 Electric shifting motor

42 Drive motor

44 Control device

50 Time sequence diagrams

t Time

t₁ Time of receipt of gear-shifting request

t₂ Optimum starting time for the start of the shifting process

P₁ Crankset position upon receipt of a gear-shifting request

P₂ Optimum crankset position for the start of the shifting process

α₁Current crankset angle (current position)

α₂Shift travel/shift angle range

ω Angular speed of crankset

t_{Z} Time of reaching the target position, terminating the actuation of the shift actuator

P Crank position

DC Dead center position 30/32a

M Drive torque 42

t_{R}Time of reaching the form-fitting position

Δt₁Remaining time until reaching the next DC

Δt_{R}Remaining time until form-fitting position

Δt_{b}Actuation stop until form-fitting position

P_{R} Form-fitting position 38

P_{Z} Target position 38

P_{b} Lower acceptance limit for target position

Pₜ Upper acceptance limit for target position

ΔP_{b} Lower acceptance range for target position

ΔPₜ Upper acceptance range for target position

T_{Bl} Blocking period

P_{Bl} Blocking position 38

What is claimed is:

1. A drive unit for a vehicle, comprising:
a transmission arrangement for setting up a plurality of gear stages, in which a form-fitting connection of two transmission elements is set up in each case, wherein the transmission arrangement has an input shaft, which is connectable to drive cranks, and an output shaft, which can be coupled to an output, and
a control device for carrying out gear changes, wherein the control device is configured to carry out the following steps:
receiving a gear-shifting request to a target gear stage,
calculating an optimum starting condition of the shifting process, wherein a shift time period required for the shifting process is calculated, and
starting the shifting process when the expiration of the shift time period coincides with an optimum time for setting up the form-fitting connection of the target gear stage so that the optimum starting condition is met.

2. The drive unit according to claim 1, wherein the calculation of the optimum starting condition is carried out at least on the basis of: (i) the current position of a crankset, (ii) the current rotational frequency of the crankset, (iii) a speed of a shift actuator used to set up the form-fitting connection of the target gear stage, and (iv) an actuator travel until the form-fitting connection of the target gear stage is set up.

3. The drive unit according to claim 1, further comprising:
a drive motor which is configured to feed a motor drive torque for driving the vehicle into the transmission arrangement, and wherein the control device is configured to carry out at least one of the following steps:
reducing the motor drive torque of the drive motor after the shifting process has started, and/or
reducing the motor drive torque of the drive motor before the form-fitting connection of the target gear stage is set up.

4. The drive unit according to claim 1, wherein the control device is configured to adapt a motor speed of a drive motor to a gear ratio of the target gear stage when the form-fitting position of the target gear stage is reached.

5. The drive unit according to claim 1, wherein the control device is configured to adapt a motor speed of a drive motor to a gear ratio of the target gear stage a time period before the form-fitting position of the target gear stage is reached.

6. The drive unit according to claim 1, wherein the control device is connected to a shift actuator system.

7. The drive unit according to claim 6, wherein the control device is configured to actuate the shift actuator system in the direction of a form-fitting position of the target gear stage upon receipt of a shifting request and to terminate the actuation on at least one of the following conditions:
after the form-fitting position has been reached, and/or
before a target position is reached, so that the target position can be reached due to mass inertia.

8. A drive unit for a vehicle, comprising:
a transmission arrangement for setting up a plurality of gear stages, in which a form-fitting connection of two transmission elements is set up in each case, wherein the transmission arrangement has an input shaft, which is connectable to drive cranks, and an output shaft, which can be coupled to an output, and
a control device for carrying out gear changes, wherein the control device is configured to carry out the following steps:
receiving a gear-shifting request to a target gear stage,
calculating an optimum starting condition of the shifting process, and
starting the shifting process when the optimum starting condition is met so that the form-fitting connection of the target gear stage is set up at an optimum time,
wherein the calculation of the optimum starting condition of the shifting process includes calculating whether a form-fitting position of the target gear stage can be reached when the next dead center position of the input shaft is reached or whether the form-fitting position of the target gear stage can only be reached when the second subsequent dead center position of the input shaft is reached.

9. The drive unit according to claim 1, wherein the control device is configured to adjust an actuator speed of a shift actuator system depending on the type of shifting process.

10. The drive unit according to claim 9, wherein the control device is configured to set the actuator speed of the shift actuator system to be higher for a double gear change than for a single gear change.

11. A drive unit for a vehicle, comprising:
a transmission arrangement for setting up a plurality of gear stages, in which a form-fitting connection of two transmission elements is set up in each case, wherein the transmission arrangement has an input shaft, which is connectable to drive cranks, and an output shaft, which can be coupled to an output, and
a control device for carrying out gear changes, wherein the control device is configured to detect an actuator position of a shift actuator system for carrying out gear changes and, in the event that the shift actuator system has exceeded an actuator position corresponding to the target position of the target gear stage during a shifting process to a target gear stage, to actuate the shift actuator system in an opposite direction.

12. The drive unit according to claim 11, wherein the control device is configured to reduce an actuator speed of the shift actuator system in the direction of the target position during a subsequent actuation.

13. The drive unit according to claim 1, wherein the control device is configured to detect an actuator position of a shift actuator system for carrying out gear changes and, in the event that the actuator position does not change for a predetermined blocking period during a shifting process to a target gear stage before a form-fitting position of the target gear stage is reached, is configured to actuate the shift actuator system in at least one of:
a pulsating manner with regard to a control variable, and/or
back and forth in a pulsating manner with regard to a shift travel.

14. The drive unit according to claim 13, wherein the control device is configured to abort the shifting process if, despite the pulsating actuation of the shift actuator system for a pulsation period, the form-fitting position of the target gear stage is not reached.

15. The drive unit according to claim 1, wherein the control device is configured to detect a multiple shifting request and, in this case, to set the actuator speed of a shift actuator system to be higher than for a single gear change.

16. The drive unit according to claim 1, wherein the control device is configured to check, after the form-fitting connection of the target gear stage has been established, whether the form-fitting connection has been set up at the optimum time and, if not, to include the deviation in the future calculation of the optimum starting condition.

17. The drive unit according to claim 1, wherein the control device is configured to learn a dead center position and to include it in the future calculation of the optimum starting condition.

18. The drive unit according to claim 1, wherein the optimum time is a time at which a crankset of the vehicle, via which muscle power is introduced for driving the vehicle, is in a dead center position, so that setting up the form-fitting connection of the target gear stage coincides with the dead center position.
